(19) United States
(12) Patent Application Publication
(10) Pub. No.: US 2012/0207889 A1
(43) Pub. Date: Aug. 16, 2012

(54) SYSTEM AND METHOD FOR COST-EFFECTIVE PRODUCTION OF A DEHYDRATED FOOD PRODUCT

(76) Inventor: GEOFFREY MARGOLIS, Los Angeles, CA (US)

(21) Appl. No.: 13/208,712

(22) Filed: Aug. 12, 2011

Related U.S. Application Data
(60) Provisional application No. 61/443,011, filed on Feb. 15, 2011.

(51) Int. Cl. A23B 4/03; A23L 1/27; A23L 1/20

(52) U.S. Cl. 426/251; 426/461; 426/634

(57) ABSTRACT

Raw beans are hydrated in a hydration/wetting liquid (water or a broth of water and bean solids) in a stationary hydration vessel for an amount of time sufficient to obtain uniformly hydrated beans. In one embodiment, more wetting liquid than necessary is used. In this embodiment, the hydrated beans are separated from the excess wetting liquid remaining at the end of hydration, and all of the excess wetting liquid is used to hydrate subsequent raw beans. In a second embodiment, the hydration liquid is of an amount such that, at the end of hydration, the hydration vessel is substantially free of excess wetting liquid; here, the beans may be agitated during hydration so as to be maintained in uniform contact with the hydration liquid. In all embodiments, the hydrated beans are then steam cooked in a separate stationary cooking vessel that contains no wetting liquid.

### RELATED APPLICATION DATA

This application claims priority from Provisional Application Ser. No. 61/443,011, filed Feb. 15, 2011, which is incorporated herein by reference in its entirety.

### BACKGROUND OF THE INVENTION

1. Field of the Invention

This invention is in the field of food products and, more particularly, directed to a method for efficiently producing a dehydrated food product, including whole cooked bean (and other such similar) products.

2. Background

The prevalence of fast-food style establishments in recent years has been accompanied by an increased demand for reconstitutable food products, such as, for example, dehydrated refried beans and whole beans. From an economic point of view, such products have several advantages. For example, each establishment can buy and store the product in bulk quantities without the risk of spoilage. Also, since the product is normally reconstituted in a matter of minutes by adding only water, there are savings in time, energy, and labor associated with the use of these products. Finally, since there is no need to continually prepare the food product in the conventional matter (i.e., to make the food fresh, and on a daily basis), there is also no need for each establishment to keep extra equipment (e.g., cookware, etc.) on the premises. As such, methods have been devised to produce reconstitutable food products that, ideally, could be prepared very quickly, and would have the taste, texture, and appearance of their conventionally-prepared counterparts.

The steps required for the preparation of dehydrated cooked beans are well known. Since legumes are generally dried after harvesting to facilitate storage, the raw beans need to be first hydrated, then cooked, and ultimately dehydrated. For example, in the traditional home-preparation of cooked beans, the raw beans are soaked overnight at room temperature in an excess of water which is then discarded prior to cooking of the beans, resulting in a substantial loss of dissolved bean solids (i.e., bean solids dissolved in the excess water to be discarded). The beans are then frequently cooked at atmospheric pressure with additional water to aid in the heat transfer to the cooking beans. Alternatively, the hydrated beans can be steam cooked in a pressure cooker at above atmospheric pressure without the further addition of water, since the cooking process can now proceed through the contact and condensation of hot steam on the beans. Since pressure cooking occurs at elevated temperatures, the time to complete the cooking is much reduced. Further, no additional liquid water needs to be added to the beans.

Whereas preparation cost is not particularly relevant in the home method of cooking beans, it is especially important for the commercial success of industrially-manufactured dehydrated beans. As such, commercial manufacturers have long sought methods to, inter alia: (1) eliminate bean solids losses (such as occurs with the discarded excess hydration water of the home methods); (2) uniformly hydrate the beans (for quality reasons); (3) minimize processing times; and (4) simplify the manufacturing equipment needs so as to reduce capital requirements.

In order to minimize manufacturing costs, current methods and apparati for producing dehydrated cooked legumes have generally used two approaches, both of which suffer from significant shortcomings. In the first approach, both hydration and cooking are performed in a single vessel into which beans, water, and other ingredients are placed. Hydration and cooking occur simultaneously, and controlled amounts of water are used during this single-vessel approach in hopes that at the end of hydration/cooking, little or no water remains—only cooked hydrated beans, thus eliminating the operating costs that would be incurred through bean solids losses (in discarded broth after hydration) and higher drying energy requirements (to evaporate any excessive water/broth associated with the cooked beans).

Such single-vessel approaches have traditionally required that a rotating vessel be used so that the beans can be uniformly contacted with a small amount of water that is continuously diminishing as the water is absorbed by the beans. At the same time, since the same vessel is also simultaneously used for pressure cooking (in order to reduce cooking time for the beans), the single rotating hydration/cooking vessel must be designed to withstand above atmospheric pressures. Such rotating, high-pressure vessels, however, have major shortcomings: they are costly, and are limited in size, given the infeasibility of building and operating very large, rotating vessels. The latter, in turn, results in the need to build and use multiple rotating pressure vessels in order to achieve high manufacturing throughput in an industrial setting. U.S. Pat. No. 4,676,990 to Huffman et al. provides an example of a process that uses a single, rotating, pressure vessel to simultaneously hydrate and cook beans.

In view of the above-mentioned shortcomings, manufacturers have adopted methods that perform the hydration and cooking steps as two separate distinct steps which, in most cases, are performed in two separate vessels for throughput reasons. This approach has the advantage that the cooking step does not need to be performed in a rotating vessel (since the beans no longer need to be contacted with a diminishing quantity of water). However, the raw beans do still need to be uniformly hydrated and, as such, the hydration step is frequently performed by contacting the beans with an excess amount of water, which is then discarded, resulting in the loss of associated bean solids in the discarded broth (see, e.g., U.S. Pat. No. 4,676,990 to Huffman et al.; Japanese Patent Application No. 2-20259; and Russian Publication No. RU 2038797).

Others have taught away from the use of water as the sole hydration means. Thus, U.S. Pat. No. 5,744,188 to Kolla et al., for example, teaches a two-stage hydration process, wherein the beans are first treated with boiling water containing an alkali, and then neutralized with an acidic solution having a temperature within the 150°-190° F. range. This process, however, is not only more complicated, but also degrades bean quality, as treatment with an alkali followed by an acidic solution produces a salt. Further, any recycling of the (excess) hydration broth for subsequent hydrations only exacerbates the degradation in bean quality because, each time the broth is recycled, an additional amount of salt is produced.

Alternatively, the entire mixture of hydrated beans and excess broth (from the hydration step) may be fed into the cooker, thereby producing a cooked bean slurry, rather than a texturized bean product (see, e.g., U.S. Pat. No. 4,407,840 to Lathrop et al.). In the latter case, bean-solids losses are eliminated, but drying is difficult and more costly due to the excess water that needs to be evaporated during the drying of the cooked beans.

Existing methods have also addressed the issue of water absorption and uniform hydration in additional ways. For example, within the context of processes for producing a reconstitutable dehydrated bean product while, at the same time, minimizing both yield loss and flatulence in the final product, RE41885 to Margolis describes a hydration vessel in which raw beans are held below the water-air interface by means of a mechanical device throughout the hydration step. Specifically, at the beginning of the hydration step, raw beans are placed within a vertical hydration vessel and are maintained below the water-air interface (i.e., below the water, or wetting liquid, level) throughout a predetermined hydration period. Upon termination of the hydration period, beans that have been adequately hydrated generally sink to the bottom of the vessel and are removed. “Harder” beans, however, that tend to buoy up towards the upper portion of the hydration vessel are captured (e.g., by means of a mesh screen or other physical device) during hydration, and if still “hard”, removed at the end of the hydration period; such beans may be returned to the vessel for additional hydration with a subsequent batch of raw beans.

After each hydration period, a “broth” (comprising the unabsorbed portion of the wetting liquid and a proportion of bean solids) is removed from the vessel, and a portion of the removed broth may be discarded (so as to remove from the process the flatulent sugars contained in the discarded broth). The remaining broth may be used for hydrating subsequent raw beans, or some or all of the broth or bean solids therein may be returned to the beans at a later stage in the process. Thus, in a process where an optimal amount of the hydration “broth” may be discarded in order to minimize both flatulent sugars and yield loss, raw beans may be physically held below the water-air interface throughout the predetermined hydration period in order to ensure maximum water absorption by the hydrating beans. However, given its goal of striking an optimal balance between reductions in both flatulent sugars and yield loss, this process may not be optimal from an efficiency, or cost-effectiveness, point of view, as, e.g., some yield loss necessarily occurs due to the requirement that a portion of the hydration broth be discarded.

As will be described in further detail below, it has been discovered that, in improved methods for manufacturing dehydrated cooked beans on an industrial scale in which manufacturing costs are minimized, an optimized hydration time period helps ensure uniform—in addition to maximum—water absorption by the raw beans without the need for additional chemicals or a physical barrier to maintain the beans under the water-air interface.

Thus, one embodiment of the present invention is directed to hydrating raw beans in a wetting liquid in a stationary hydration vessel for an amount of time sufficient to obtain beans that are substantially fully and uniformly hydrated, wherein the wetting liquid is either water or a broth of water and bean solids, and wherein the wetting liquid remains above the level of the beans and at a temperature of at least 150° F. throughout the hydration step; separating the uniformly-hydrated beans from excess wetting liquid remaining at the end of the hydration step; using the entirety of the excess wetting liquid to hydrate subsequent raw beans; and, in a stationary cooking vessel, steam cooking the separated uniformly-hydrated beans to obtain cooked beans, wherein the cooking vessel is separate from the hydration vessel and contains substantially no wetting liquid. After cooking, the cooked beans may be used to produce a texturized bean composition with a desired consistency, and the bean composition may then be dried.

In a second embodiment, raw beans may be hydrated in a wetting liquid in a stationary hydration vessel for an amount of time sufficient to obtain beans that are substantially fully and uniformly hydrated, wherein the beans are agitated so as to be maintained in uniform contact with the wetting liquid, wherein the wetting liquid is either water or a broth of water and bean solids, is maintained at a temperature of at least 150° F. throughout the hydration step, and is of a predetermined amount such that, at the end of the hydration step, the hydration vessel is substantially free of excess wetting liquid. The uniformly-hydrated beans are then steam cooked in a stationary cooking vessel to obtain cooked beans, wherein the cooking vessel is separate from the hydration vessel and contains substantially no wetting liquid. After cooking, the cooked beans may be used to produce a texturized bean composition with a desired consistency, and the bean composition may then be dried.

The features and advantages of the present invention will become more apparent through the following description. It should be understood, however, that the detailed description and specific examples, while indicating particular embodiments of the invention, are given by way of illustration only and various modifications may naturally be performed without deviating from the spirit of the present invention.

### BRIEF DESCRIPTION OF THE DRAWINGS

FIG. 1 shows a flow-chart according to an embodiment of the invention.

FIG. 2 shows a flow-chart according to another embodiment of the invention.

FIG. 3 shows a cross-section of an inhomogeneously hydrated bean.

### DETAILED DESCRIPTION

Embodiments of the present invention are related to methods for producing a low-cost, reconstitutable, dehydrated food product wherein separate, stationary, hydration and cooking vessels are used.

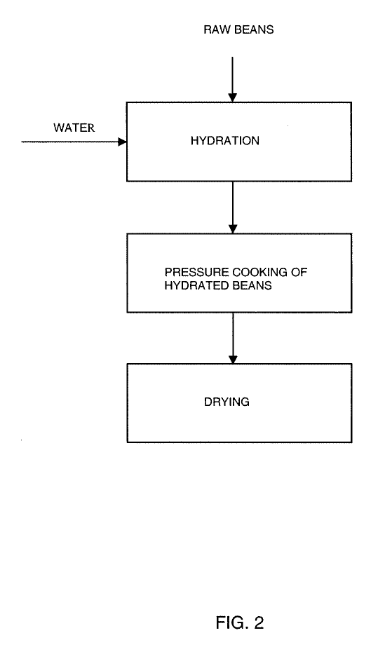

The stationary hydration vessel of the present invention has significant processing and unique advantages. First, since the vessel is stationary, it is relatively simple to construct large units which result in substantial economies of scale. Second, no physical mechanism is necessary to maintain hydrating beans below the hydrating liquid interface, resulting in significant equipment simplifications and cost savings. Third, by using a horizontal hydrating vessel with internal mixing mechanisms, it is easy to assure that, during processing, all of the beans are gently and continuously contacted with the hydrating liquid. This is especially important in an embodiment of the invention in which all of the hydration water is absorbed by the beans prior to cooking of the hydrated beans (see FIG. 2).

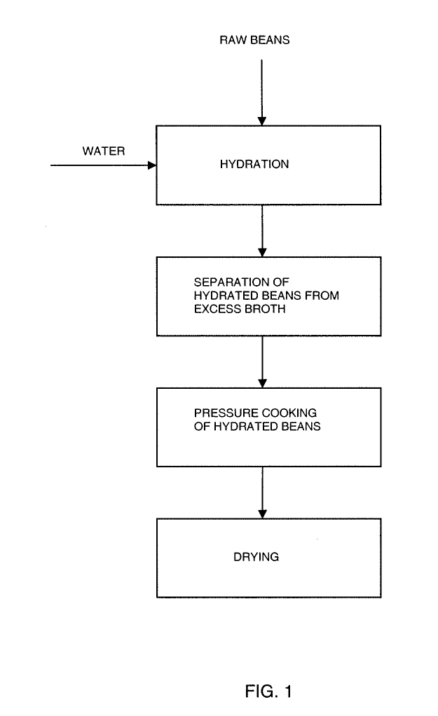

FIG. 1 shows one embodiment of the methods which may be used to practice the present invention. As shown, raw beans and excess water (i.e., water in a quantity greater than that which is required to hydrate the beans) are fed either continuously or batch-wise into a stationary, horizontal hydration vessel. The bean-water mixture is kept at a temperature of at least 150° F. throughout the hydration step in order to minimize the hydration time. The liquid level in the hydration vessel can be maintained either above or below the bean level. If the liquid level is below the bean level, then active mixing within the vessel is required to bring the beans that are above the liquid into contact with the hydrating liquid so as to achieve uniform bean hydration. On the other hand, if the liquid level is above the bean level, no physical device is needed to keep the hydrating beans below the air-liquid interface.

After a hydration period of about one hour or more, the hydrated beans and the remaining excess liquid broth are separated from one another and the hydrated beans are transported to a stationary pressure cooker. The entire quantity of the remaining excess liquid broth is used together with additional water to hydrate subsequent raw beans either continuously or batch-wise. In this manner, none of the bean solids dissolved into the excess quantity of hydration broth is lost, resulting in substantial cost savings.

The separated hydrated beans are then pressure cooked with steam in the stationary cooking vessel, which can once again operate in either a continuous or batch mode. By using steam to pressure cook the hydrated beans, the cooking time is much reduced due to the elevated cooking temperature, and in addition the final cooked beans are not surrounded by excess liquid, thereby lowering drying time and costs.

The cooked beans can then be dehydrated in a dryer. Optionally, other ingredients, such as oil, flavoring, colorants, etc.—which do not affect the hydration process—can be added to the beans at any point in the process. Further, after the beans have been cooked, they may be appropriately texturized prior to drying to produce, for example, a reconstitutable dehydrated refried bean product.

FIG. 2 shows a second embodiment of the methods which may be used to practice the present invention. Once again, for economic reasons, the hydration and cooking steps of the method are separated into two distinct steps. However, contrary to the embodiment shown in FIG. 1, the hydration step of the embodiment shown in FIG. 2 can only be executed batch-wise.

Specifically, in accordance with FIG. 2, raw beans and the exact quantity of water required for hydrating the beans (as well as, optionally, other ingredients not affecting the hydration process) are placed in a stationary hydration vessel equipped with an internal mixing device (e.g., internal baffles rotatable about an axis of the vessel). The water-bean mixture is maintained at a temperature of at least 150° F. throughout the hydration step. The mixing device is designed to maintain the beans in intimate and uniform contact with a diminishing quantity of hydrating liquid. When all of the hydrating liquid has been absorbed by the beans, the bean hydration is completed, and the beans are transferred to a stationary pressure cooker. Since the entirety of the hydration liquid is absorbed by the beans, no bean solid losses occur, resulting in substantial savings. In addition, this process entails much lower drying-energy costs as there is virtually no need for evaporating any excessive water/broth associated with the cooked beans.

The above-described batch hydration process is then repeated with new raw beans. After each batch-hydration step, the cooking, drying, and other optional steps described above for the embodiment depicted in FIG. 1 can be equally applied to the second embodiment.

The following experiments were conducted in connection with the various embodiments of the present invention:

### Example 1

1000 gms of water were heated to 120° F. and placed together with 200 gms of dry raw pinto beans in a 7-inch diameter container. The water level was several inches above the beans that immediately dropped to the bottom of the container.

The bean-water mixture was maintained at 119°-128° F. for 35 minutes. During this period, none of the beans rose to the air-water interface. At the end of the 35-minure period, the beans were separated from the hydration water, and the surface moisture was removed from the beans by an absorbent paper towel. The weight of these surface-dried beans was 330 gms.

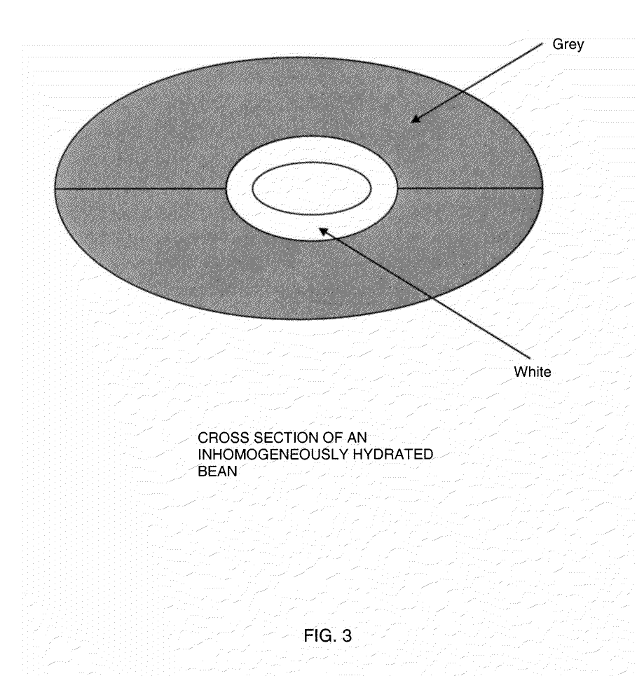

The hydrated beans appeared hard and when cut transverse to their long dimension, a significant portion of their cross-section was white colored, indicating inhomogeneous hydration (see FIG. 3).

### Example 2

Example 1 was repeated, except that the bean-water mixture was kept at approximately 150° F. for 35 minutes. Initially, all beans dropped to the bottom of the container, and throughout the experiment, only 2 to 3 beans floated at the air-water interface. At the end of the hydration period, the surface moisture was removed from the beans, which were then found to weigh 348 gms. A representative sample of the beans were then cut transverse to their long dimension, and the coloration of the cross-section was noted as follows:
22% of sample beans were uniformly grey throughout, indicating uniform hydration;
53% of sample beans had some remaining diffuse white portions, indicating partial to complete hydration; and
25% of sample beans had a clear white section indicating non-uniform hydration (see FIG. 3).

### Example 3

Example 1 was repeated, except that the bean-water mixture was kept at between 170° F. and 190° F. for 35 minutes.

Initially, all beans dropped to the bottom, but within 5 to 8 minutes of the start of the experiment, the entire air-water interface was covered with floating beans. However, after about 13 minutes, most beans had dropped back to the bottom of the container, and at the termination of the experiment (after 35 minutes) no beans were floating.

The surface-dried beans weighed 374 gms. A representative sample of the beans were then cut transverse to their long dimension, and 100% of the beans were observed to have a distinct white area in their cross-section. Evidently, despite the fact that the beans had absorbed the most water when compared to Examples 1 and 2, the bean hydration was completely inhomogeneous. In other words, maximum water uptake by the beans did not necessarily translate into uniformly-hydrated beans.

### Example 4

Example 2 (at approximately 150° F.) was repeated, but the experiment was run for 105 minutes, consisting of three 35-minute sections. Initially, all beans dropped to the bottom of the container, but throughout the first 35 minutes of the experiment, 2 to 4 beans (out of a total of about 660 beans) were observed to be floating. The experiment was stopped at 35 minutes, and the surface-dried beans weighed 352 gms. A small representative sample (10 gms) of the hydrated beans showed that 64% of the beans had some diffuse white sections, while 36% had clear white sections. Clearly the hydration after 35 minutes was still inhomogeneous.

The beans were then returned to the separated broth and held for an additional 35 minutes at a temperature of approximately 150° F. Only 2 to 3 beans remained floating at the air-broth interface. This second part of the experiment was stopped after 35 minutes, and the surface-dried beans weighed 376 gms.

Once more, a small representative sample (10 gms) of the beans that had been hydrated for 70 minutes (=2×35 minutes) was examined as described previously. 75% of these beans were uniformly grey in color indicating complete and uniform hydration. The remaining 25% had some white sections indicating inhomogeneous hydration. Once more the beans were returned to the separated broth and held for a final 35 minutes at a temperature of approximately 150° F. Only 2-3 beans remained floating at the air-broth interface. At the completion of the final 35-minute period, the surface-dried beans weighed 374 gms and all the beans were uniformly grey throughout, indicating homogenous hydration.

Thus, it appears that at 150° F., although the beans were able to essentially absorb the maximum amount of water within about 70 minutes, they still needed an additional 35 minutes for the water to uniformly diffuse throughout the bean so as to produce uniformly-hydrated beans.

### Example 5

Example 4 was repeated with the bean-water maintained at 180°-190° F. Throughout the entire first 35 minutes of the experiment, approximately 10 to 20 beans were floating at the air-water interface. At the end of 35 minutes, the surface-dried beans weighed 376 gms, and 100% of a 10 gm sample of beans had a distinct white section showing in their cut cross-section.

The beans were returned to the separated broth and held at approximately 190° F. for a second 35-minute period. This time, there were only 1 to 2 floating beans. At the end of the second 35-minute period, the surface-dried beans weighed 378 gms. Now, 81% of the sampled beans still showed a distinct white section in their cut cross-section, with the remaining 19% of beans being uniformly grey in color.

The beans were returned to the separated broth and held at approximately 190° F. for a final 35-minute period. No floating beans were observed. At the end of this final 35-minute period, the beans weighed 378 gms and were all uniformly grey in color across their cut cross-section, indicating uniform hydration.

Clearly, from these examples, it can be concluded that:

(1) A temperature of at least 150° F. is required for maximum hydration in the minimum time period. On the other hand, hydration at temperatures that are much higher than 150° F. does not shorten the amount of time required to obtain uniformly-hydrated beans. Thus, beans may be uniformly hydrated in the minimum time period at a temperature of at, or somewhat above, 150° F., rather than at much higher temperatures, thereby providing a reduction in energy costs.

(2) An additional time period is required for the beans to become uniformly hydrated. If the beans are not uniformly hydrated, it has been observed that the white portions of the inhomogeneous beans accentuate the grittiness of the final dehydrated cooked product.

(3) Even though some beans float in the early part of the hydration process (particularly when the hydration is done at an elevated temperature), by the time the hydration process is completed, there are no remaining floating beans. Evidently, a mechanical constraint (such as a screen) is not necessary to continuously maintain the beans below the air-liquid interface. This greatly simplifies the design, the equipment capital cost, and consequently, the manufacturing cost, of the hydration vessel.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, and all changes which come within the meaning and range of equivalency of the claims are therefore intended to be embraced therein.

What is claimed is:

1. A method for producing a reconstitutable dehydrated bean product, the method comprising:
(a) in a stationary hydration vessel, hydrating raw beans in a wetting liquid for an amount of time sufficient to obtain uniformly, and substantially fully, hydrated beans, wherein said wetting liquid is selected from the group consisting of water and a broth of water and bean solids;
(b) separating said hydrated beans from excess wetting liquid remaining at the end of step (a);
(c) using substantially all of said excess wetting liquid to hydrate subsequent raw beans;
(d) in a stationary cooking vessel, steam cooking said separated hydrated beans to obtain cooked beans, said cooking vessel being separate from said hydration vessel and containing substantially no wetting liquid; and
(e) drying said cooked beans.

2. The method of claim 1, wherein the wetting liquid remains above the level of the beans throughout the hydration step.

3. The method of claim 1, wherein, in step (a), the wetting liquid is at a level below the level of the beans.

4. The method of claim 3, further including mixing the beans throughout the hydration step so as to bring beans that are above the wetting liquid level into contact with the wetting liquid.

5. The method of claim 4, wherein the beans are mixed with an internal mixing device.

6. The method of claim 1, wherein the hydration vessel is horizontal.

7. The method of claim 1, further including adding at least one of an oil, a flavoring, and a colorant prior to step (e).

8. The method of claim 1, wherein, after step (d), a texturized bean composition with a desired consistency is produced from said cooked beans, and wherein the texturized bean composition is dried in step (e).

9. The method of claim 1, wherein the wetting liquid remains at a temperature of about 150° F. throughout the hydration step.

10. A method for producing a reconstitutable dehydrated bean product, the method comprising:
(a) in a stationary hydration vessel, hydrating raw beans in a wetting liquid for an amount of time sufficient to obtain uniformly, and substantially fully, hydrated beans, wherein said beans are mixed so as to be maintained in uniform contact with the wetting liquid, wherein the wetting liquid is selected from the group consisting of water and a broth of water and bean solids, and wherein the wetting liquid is of a predetermined amount such that, at the end of the hydration step, the hydration vessel is substantially free of excess wetting liquid;
(b) in a stationary cooking vessel, steam cooking said hydrated beans to obtain cooked beans, said cooking vessel being separate from said hydration vessel and containing substantially no wetting liquid; and
(c) drying said cooked beans.

11. The method of claim 10, wherein, after step (b), a texturized bean composition with a desired consistency is produced from said cooked beans, and wherein the texturized bean composition is dried in step (c).

12. The method of claim 10, wherein the hydration vessel is horizontal.

13. The method of claim 10, further including adding at least one of an oil, a flavoring, and a colorant prior to step (c).

14. The method of claim 10, wherein, in step (a), the beans are mixed with an internal mixing device.

15. The method of claim 10, wherein the wetting liquid is maintained at a temperature of about 150° F. throughout the hydration step.
